(19) United States
(12) Patent Application Publication
(10) Pub. No.: US 2014/0003656 A1
(43) Pub. Date: Jan. 2, 2014

(54) SYSTEM OF A DATA TRANSMISSION AND ELECTRICAL APPARATUS

(71) Applicant: QUANTA COMPUTER INC., Kuel Shan Hsiang (TW)

(72) Inventor: Kang-Wen Lin, Kuei Shan Hsiang (TW)

(73) Assignee: Quanta Computer Inc., Kuel Shan Hsiang (TW)

(21) Appl. No.: 13/872,358

(22) Filed: Apr. 29, 2013

(30) Foreign Application Priority Data
Jun. 29, 2012 (TW) 101123389

(51) Int. Cl. G06K 9/32

(52) U.S. Cl. CPC G06K 9/3241
USPC 382/103

(57) ABSTRACT

A system for data transmission includes a first electrical device displaying video data, a second electrical device having an image capture unit for taking pictures for the first electrical device to generate a first output image, and a server storing electrical device data and pre-stored multimedia data, recognizing the video data displayed on the first electrical device according to the first output image, and transmitting the video data to the second electrical device.

### CROSS REFERENCE TO RELATED APPLICATIONS

This Application claims priority of Taiwan Patent Application No. 101123389, filed on Jun. 29, 2012, the entirety of which is incorporated by reference herein.

### BACKGROUND OF THE INVENTION

1. Field of the Invention

The disclosure is related to data transmission, and, more particularly, to recognizing an electrical device by the output image of a camera for data transmission.

2. Description of the Related Art

Recently, because of the rapid development of wireless communications, portable devices, such as smart phone, personal digital assistant, tablet PC, are available, and have become more and more technically advanced and multifunctional. Due to increased convenience and functions of the devices, these devices have become necessities of life.

Sharing multimedia files is a main development of digital family application. Previously, during the computer-age, the environment for sharing multimedia files was via a local network. However, recently, because of the rapid development of portable devices, and the popularity of the wireless internet, sharing multimedia files not via the local network has become common

When user watches an interested multimedia image, such as a movie or animation displayed on an electrical device in a store, the user can't acquire the data of the movie or animation immediately. Therefore, the user can't display the movie or animation on own portable device (such as smart phone and tablet PC) simultaneously and immediately.

### BRIEF SUMMARY OF THE INVENTION

An embodiment of the invention provides a data transmission system, comprising: a first electrical device, displaying a video data; a second electrical device, having an image capture unit for taking pictures for the first electrical device to generate a first output image; and a server, storing a plurality of electrical device data and pre-stored multimedia data bases, recognizing the first electrical device and the video data displayed on the first electrical device according to the first output image, and transmitting the video data to the second electrical device.

An embodiment of the invention provides an electrical device, comprising an image capture unit, taking pictures for other electrical device to generate a first output image and transmitting the first output image to a server, wherein the server stores a plurality of electrical device data and pre-stored multimedia data bases, and recognizes the other electrical device and a video data displayed on the other electrical device according to the first output image, and transmits the video data to the electrical device.

An embodiment of the invention provides an electrical device, comprising a plurality of electrical device data and pre-stored multimedia data bases, wherein the electrical device receives an output image which is generated by a first electrical device taking pictures for a second electrical device, recognizes the second electrical device and a video data displayed on the second electrical device and transmits the video data to the first electrical device

### BRIEF DESCRIPTION OF THE DRAWINGS

The invention will become more fully understood by referring to the following detailed description with reference to the accompanying drawings, wherein:

FIGS. 1A-1B are schematic diagrams illustrating the data transmission system 100 according to an embodiment of the invention;

FIG. 1C is a schematic diagram illustrating the data transmission system 100 according to another embodiment of the invention;

FIG. 2 is a schematic diagram illustrating the completion of the data transmission by a gesture action according to an embodiment of the invention;

FIG. 3A is a flowchart of a data transmission method according to an embodiment of the invention;

FIG. 3B is a flowchart of step S330 of a data transmission method according to an embodiment of the invention;

FIG. 4 is a flowchart of a data transmission method according to another embodiment of the invention.

### DETAILED DESCRIPTION OF THE INVENTION

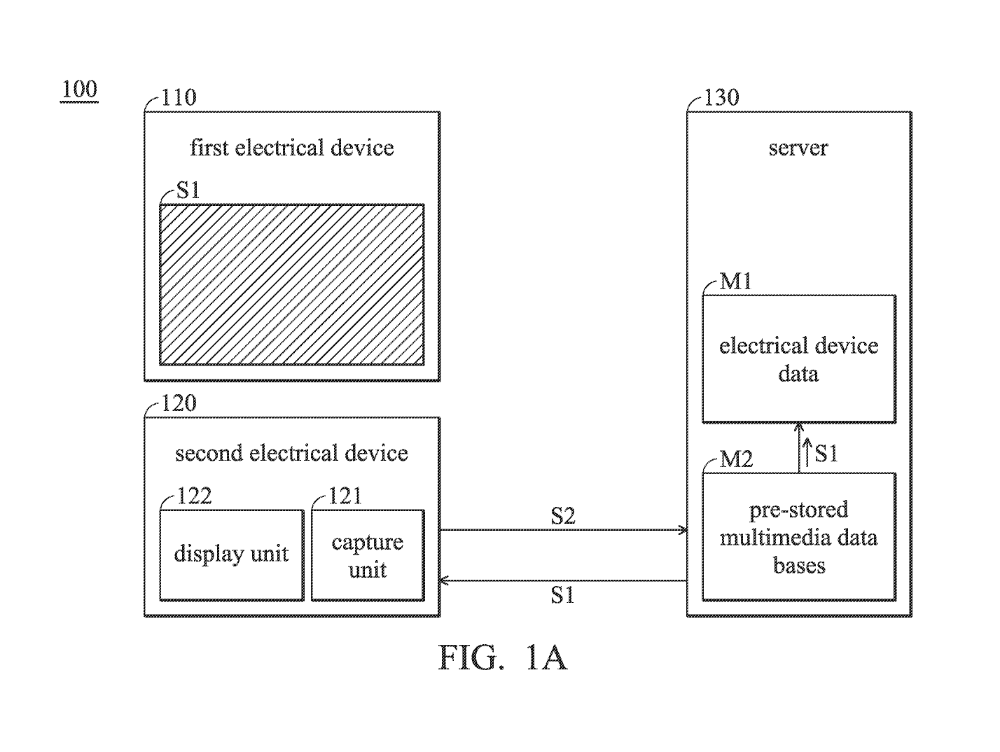

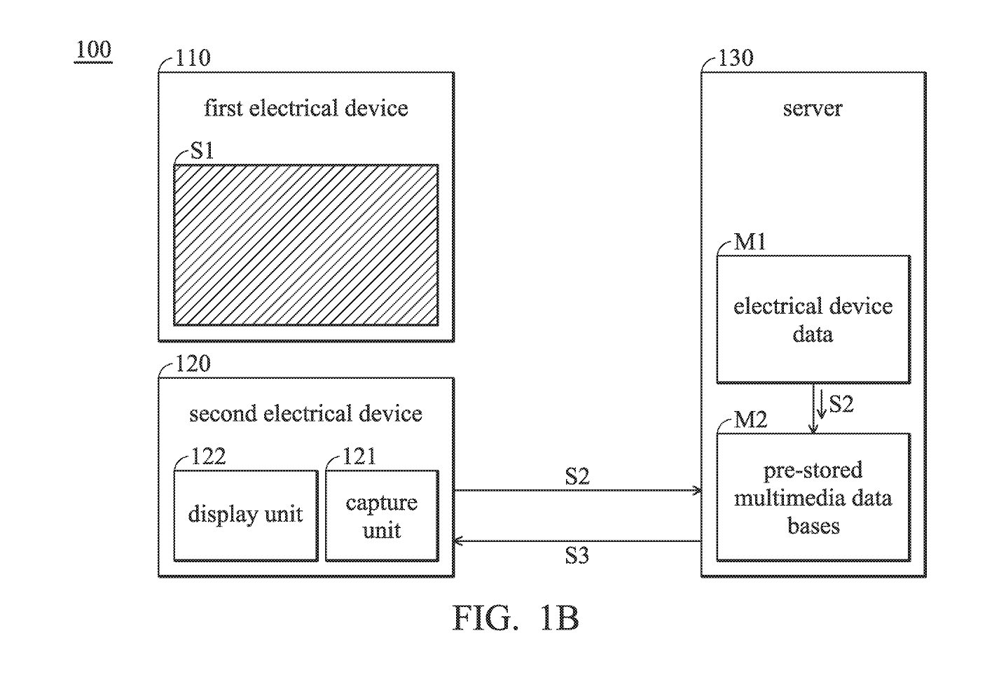

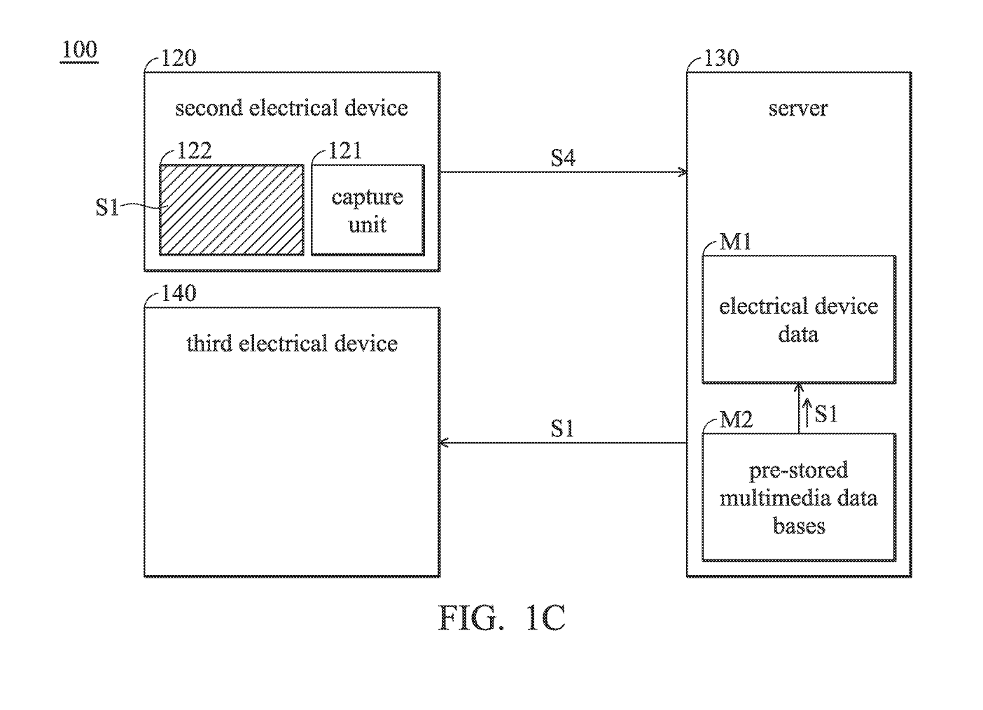

FIGS. 1A-1B are schematic diagrams illustrating the data transmission system 100 according to an embodiment of the invention. In the FIGS. 1A-1B, the data transmission system 100 comprises a first electrical device 110, a second electrical device 120, and a server 130. Specially speaking, the second electrical device 120 must be an electrical device which has registered with the server 130. However, the first electrical device 110 needn't be an electrical device which has registered with the server 130. The server 130 can transmit the data to the registered electrical device by a wire or wireless transmission.

In an embodiment of the invention, the first electrical device 110 is configured to display video data S1, wherein the video data S1 is an image file or a video stream in the internet. The second electrical device 120 has an image capture unit 121 such as a camera (the camera is referred to as the image capture unit 121 hereafter). The camera 121 can take pictures for the first electrical device 110 to generate the first output image S2 and upload the first output image S2 to the server 130, wherein the first output image comprises the image of the first electrical device 110 and the video data S1 displayed on the first electrical device 110. In an embodiment of the invention, the server 130 stores a plurality of electrical device data M1 (the registered data) and a plurality of multimedia data bases M2 which is pre-stored in the server 130. The server 130 recognizes the first electrical device 110 and the video data S1 displayed on the first electrical device 110 according to the first output image S2, and transmits the video data S1 to the second electrical device 120. Then, the second electrical device 120 can display the video data S1 displayed on the first electrical device 110.

In an embodiment of the invention, the electrical device data M1 comprises a model number, location information, a brand, and an image of the external appearance of registered electrical devices. For example, if the first electrical device 110 has registered in the server 130, the server 130 can obtain the model number, the brand, the external appearance and the display state of the first electrical device 110 from the electrical device data M1. The server 130 further can obtain the location of the first electrical device 110 (for example, the first electrical device 110 has a positioning device for continuously reporting the location information of the electrical device 110 to the server 130). The model number, the brand and the external appearance are used to recognize the electrical device, and the display state, which is continuously reported to the server 130, is used to record whether the electrical device is in a display state and multimedia information, such as the name or title of a movie, actors in the movie, a movie time, and display progress of the movie.

In an embodiment of the invention, the multimedia data base M2 comprises a plurality of files and information which are pre-stored in the server 130. For example, if an electrical device processes registration in the server 130, the electrical device can upload the multimedia files and information therein to the sever 130. In addition, the server 130 also can obtain other multimedia file or video information, and the related link from the website such as Youtube or youku.

In the FIG. 1A, if the electrical device which is recognized by the server 130 is the registered first electrical device 110, the server 130 can be informed of the video data S1 displayed on the first electrical device 110 by the continuously updated display state from the first electrical device 110, therefore the server 130 can obtained the video data S1 displayed on the first electrical device 110 from the multimedia data base M2 or the first electrical device 110 (not shown), and then transmit the video data S1 to the second electrical device 120. In an embodiment of the invention, the server 130 recognizes whether the electrical device is the first electrical device 110 by comparing the model number, brand and external appearance in the first output image S2 with the model number, brand and external appearance which are uploaded to the server 130 from the first electrical device 110 during registration process.

If the video data S1 displayed on the first electrical device 110 does not pre-store in the multimedia data base M2, for example, the video data S1 is the built-in file or captured recently, the server 130 searches the multimedia data base M2 to determine whether the multimedia data base M2 comprises a multimedia data S3 as the same as the video data S1 according to the first output image S2. If the multimedia data base M2 comprises a multimedia data S3 as the same as the video data S1, the server 130 transmits the multimedia data S3 to the second electrical device 120. In an embodiment of the invention, the server 130 can recognize whether the facial image or subtitle (or voice) related to the video data S1 in the first output image S2 are the same as a multimedia data or file which were pre-stored in the multimedia data base M2 by a facial recognition or a text recognition method. In another embodiment of the invention, the server 130 can recognize whether the segments of the multimedia data stored in the multimedia data base M2 are the same as the plurality of images comprised in the first output image S2, wherein the plurality of images are the pictures photographed by the camera 121 of the second electrical device 120 during every time interval which has been pre-set. Specifically speaking, the image recognition methods described above are not limited in the invention. Those who are skilled in this technology can use other image recognition methods for recognizing the video data S1.

In the FIG. 1B, if the first electrical device 110 is not registered in the server 130, the server 130 can't obtain the video data S1 displayed on the first electrical device 110 by the display state. Accordingly, the server 130 searches the multimedia data base M2 to determine whether the multimedia data base M2 comprises a multimedia data S3 as the same as the video data S1 according to the first output image S2. If the multimedia data base M2 comprises a multimedia data S3 as the same as the video data S1, the server 130 will transmit the multimedia data S3 corresponding to the video data S1 displayed on the first electrical device 110 from the multimedia data base M2 to the second electrical device 120.

For example, when a user is watching an interesting movie displayed on a digital television in a store. The user can use their own smart phone camera which is registered in the server to capture an image comprising the digital television and the movie displayed thereon, and then uploads the image to the server. The server will recognize whether the digital television is registered in the server. If the digital television has been registered in the server, the server will transmit the movie displayed on the digital television to the user's smart phone either getting the movie from the multimedia data base or digital television. If the digital television has been not registered in the server, the server will recognize whether the multimedia data base comprises a video data (or multimedia data) as the same as the movie displayed on the digital television. If the multimedia data base comprises the video data as the same as the movie displayed on the digital television, the server then transmits the video data to the user's smart phone, and then the smart phone may display the movie when receiving the video data from the server. In an embodiment of the invention, recognizing whether the digital television is registered in the server is accomplished by comparing the model number, brand and external appearance in the output image with the model number, brand and external appearance which were uploaded to the server when the electrical device was registered in the server.

In an embodiment of the invention, when the server 130 transmits the video data S1 to the second electrical device 120, according to the display progress information of the display state, the server 130 can transmit the part of the video data S1 which is after the display progress. Therefore, the second electrical device 120 can display the video data S1 at the time point when the first electrical device 110 is displaying the video data S1, and the second electrical device 120 doesn't need to display the video data S1 from the beginning of the video data S1 and doesn't need to adjust the display time point of the video data S1.

FIG. 1C is a schematic diagram illustrating the data transmission system 100 according to another embodiment of the invention. In FIG. 1C, the data transmission system 100 further comprises a third electrical device 140, wherein the third electrical device 140 has been registered in server 130. The second electrical device 120 is playing the video data S1 stored in the multimedia data base M2. The second electrical device 120 takes pictures for the third electrical device 140 by the camera 121 to generate a second output image S4 and transmits the second output image S4 to the server 130. The server 130 can recognize the third electrical device 140 according to the second output image S4 and transmits the video data S1 displayed on the second electrical device 120 to the third electrical device 140. The user can display the video data S1 through the third electrical device 140 when the user wants to use the third electrical device 140 to display the video data S1 displayed on the second electrical device 120 according to above method.

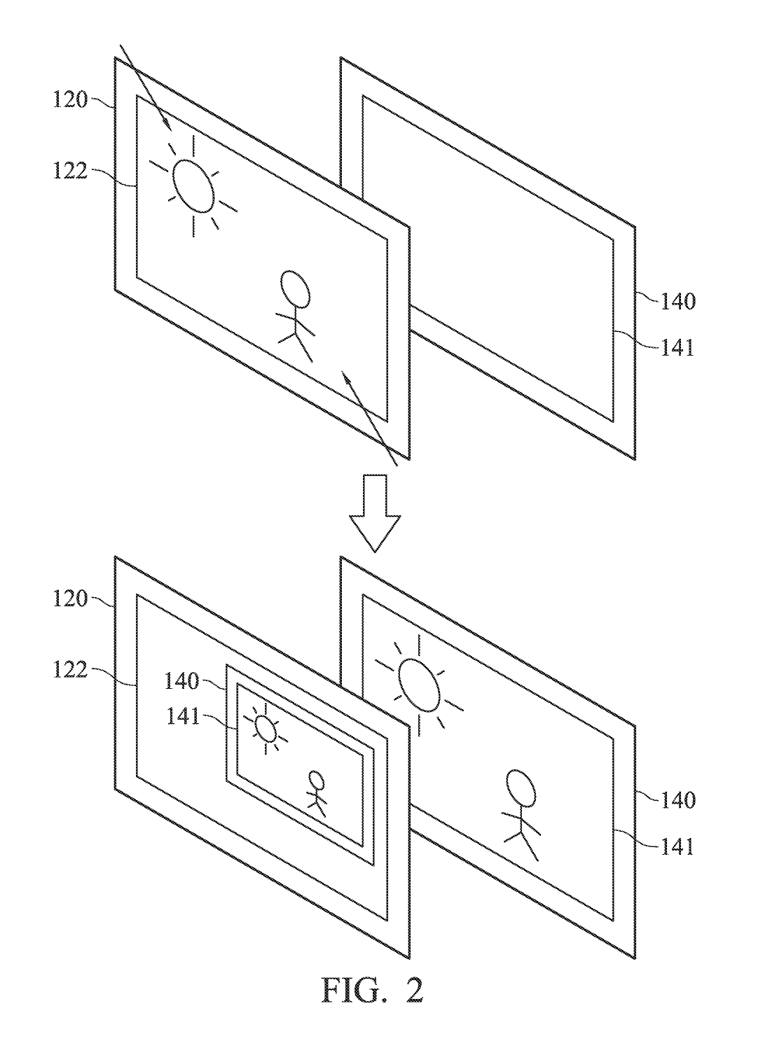

FIG. 2 is a schematic diagram illustrating the completion of the data transmission by a gesture action according to an embodiment of the invention. In the upper part of the FIG. 2, when the second electrical device 120 is playing the video data S1, the second electrical device 120 transmits an indicating signal corresponding to the gesture action to the sever 130. After the server 130 receives the indicating signal corresponding to the gesture action on the display unit 122 of the second electrical device 120, the server 130 transmits the video data S1 displayed on the second electrical device 120 to the third electrical device 140. Then, the display unit 141 of the third electrical device 140 may display the video data S1.

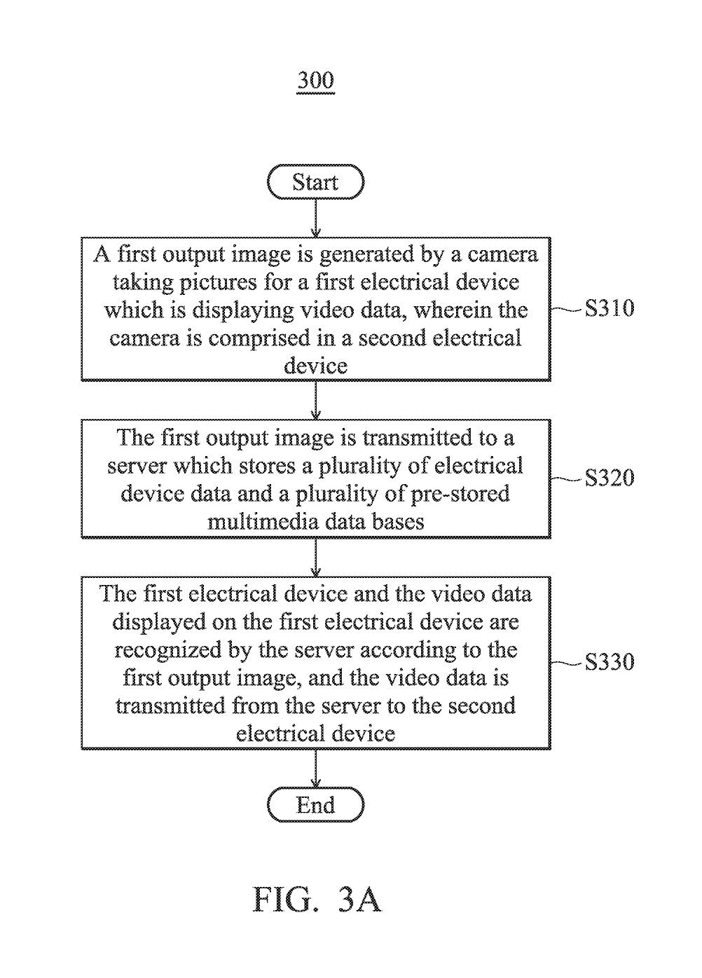

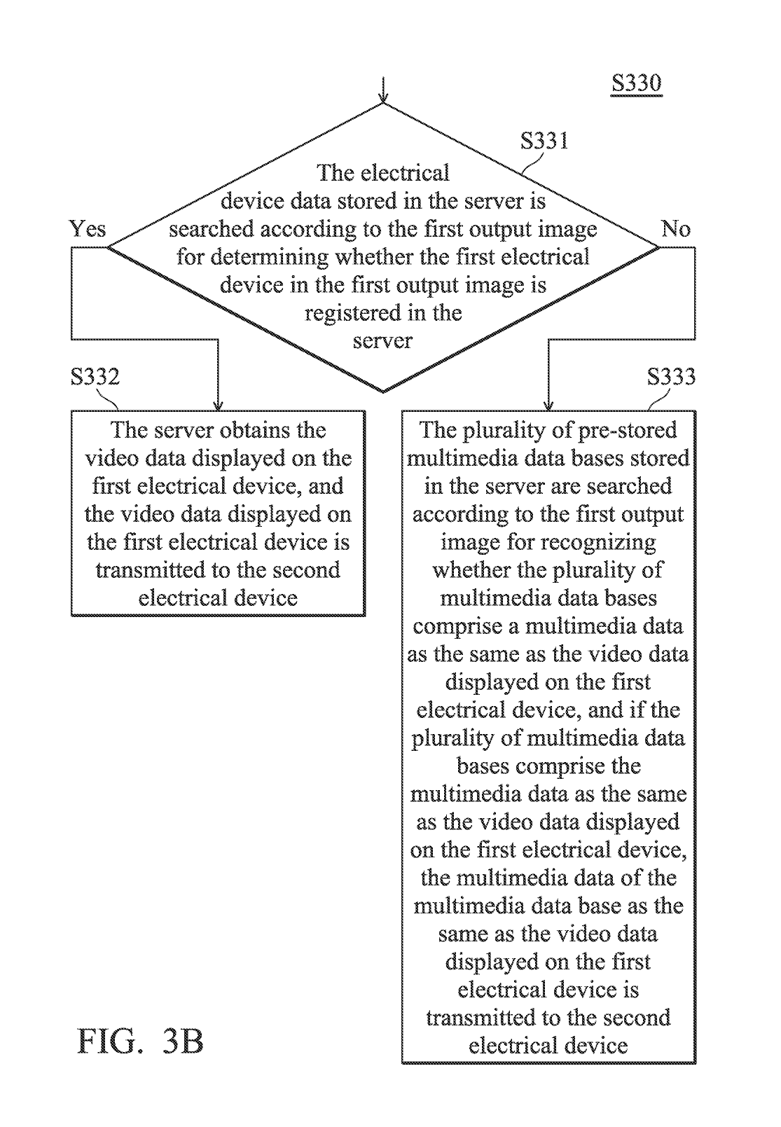

FIG. 3A is a flowchart of a data transmission method according to an embodiment of the invention. In step S310, a first output image is generated by a camera taking pictures for a first electrical device which is displaying video data, wherein the camera is comprised in a second electrical device. In step S320, the first output image is transmitted to a server which stores a plurality of electrical device data and a plurality of pre-stored multimedia data bases. In step S330, the first electrical device and the video data displayed on the first electrical device are recognized by the server according to the first output image, and the video data is transmitted from the server to the second electrical device. FIG. 3B is a flowchart of step S330 of a data transmission method according to an embodiment of the invention. Step S330 further comprises step S331, step S332 and step S333. In step S331, the electrical device data stored in the server is searched according to the first output image for determining whether the first electrical device in the first output image is registered in the server. If the first electrical device is registered in the server, the step S332 is processed. In step S332, the server obtains the video data displayed on the first electrical device, and the video data displayed on the first electrical device is transmitted to the second electrical device.

If the first electrical device is not registered in the server, the step S333 is processed. In step S333, the plurality of pre-stored multimedia data bases stored in the server are searched according to the first output image for recognizing whether the plurality of multimedia data bases comprise a multimedia data as the same as the video data displayed on the first electrical device, and if the plurality of multimedia data bases comprise the multimedia data as the same as the video data displayed on the first electrical device, the multimedia data of the multimedia data base as the same as the video data displayed on the first electrical device is transmitted to the second electrical device. Step S333 is processed according to the image recognition method described above.

Specially speaking, in step S332, if the video data displayed on the first electrical device is pre-stored in the plurality of the multimedia data bases of the server, the server can transmit the video data to the second electrical device directly. If the video data displayed on the first electrical device is not pre-stored in the server, video data can be transmitted by the image recognition method as according to step S333.

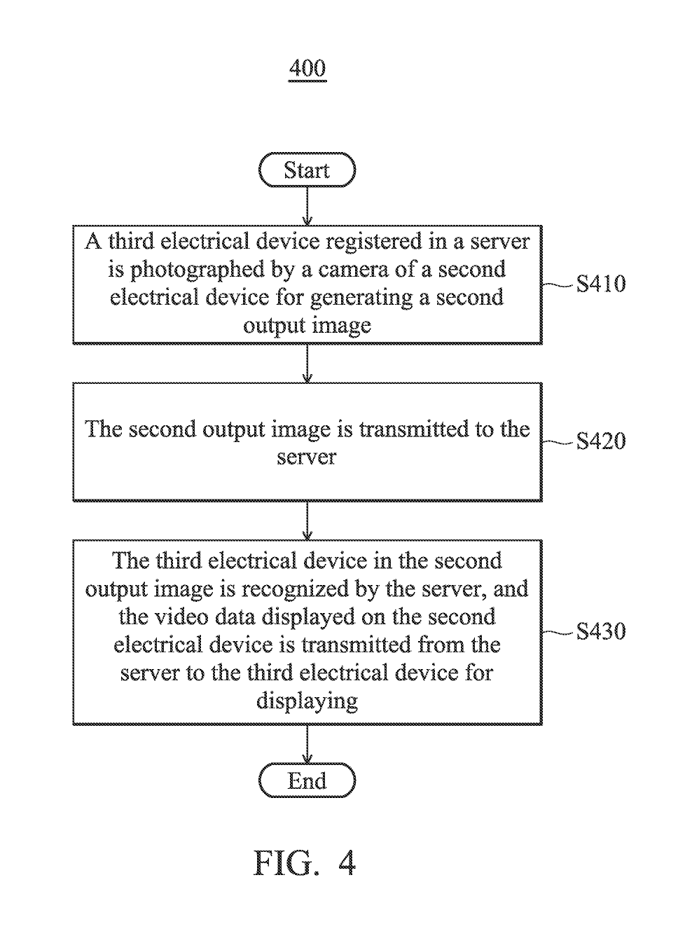

FIG. 4 is a flowchart of a data transmission method according to another embodiment of the invention. In step S410, a third electrical device registered in a server is photographed by a camera of a second electrical device for generating a second output image. In step S420, the second output image is transmitted to the server. In step S430, the third electrical device in the second output image is recognized by the server, and the video data displayed on the second electrical device is transmitted from the server to the third electrical device for displaying.

In the data transmission method of the invention, users can upload the picture photographed by the camera of their own electrical device to the server directly. Then the server may recognize the video data displayed on the other electrical device in the picture and transmit the video data to the electrical device of users. Therefore, the user can obtain the video data displayed on other electrical devices directly according to the method. Otherwise, users can also transmit the video data displayed on their own electrical device to other desired electrical devices by a simple gesture.

The above paragraphs describe many aspects of the invention. Obviously, the teaching of the invention can be accomplished by many methods, and any specific configurations or functions in the disclosed embodiments only present a representative condition. Those who are skilled in this technology can understand that all of the disclosed aspects in the invention can be applied independently or be incorporated.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A data transmission system, comprising:
a first electrical device, displaying a video data;
a second electrical device, having an image capture unit for taking pictures for the first electrical device to generate a first output image; and
a server, storing a plurality of electrical device data and pre-stored multimedia data bases, recognizing the first electrical device and the video data displayed on the first electrical device according to the first output image, and transmitting the video data to the second electrical device.

2. The data transmission system of claim 1, wherein the server searches the electrical device data according to the first output image for determining whether the first electrical device is registered in the server, if the first electrical device is registered in the server and the video data is stored in the pre-stored multimedia data bases, the server transmits the video data from the pre-stored multimedia data base to the second electrical device.

3. The data transmission system of claim 2, wherein if the first electrical device is not registered in the server, the server searches the pre-stored multimedia data bases according to the first output image for determining whether the pre-stored multimedia data bases comprise a multimedia data as the same as the video data displayed on the first electrical device, and if the pre-stored multimedia data bases comprise the multimedia data as the same as the video data displayed on the first electrical device, the server transmits the multimedia data in the pre-stored multimedia data bases as the same as the video data displayed on the first electrical device to the second electrical device.

4. The data transmission system of claim 3, wherein if the first electrical device is registered in the server and the video data is not stored in the pre-stored multimedia data bases, the server searches the pre-stored multimedia data bases according to the first output image for determining whether the pre-stored multimedia data bases comprise the multimedia data as the same as the video data displayed on the first electrical device, and if the pre-stored multimedia data bases comprise the multimedia data as the same as the video data displayed on the first electrical device, the server transmit the multimedia data in the pre-stored multimedia data bases as the same as the video data displayed on the first electrical device to the second electrical device.

5. The data transmission system of claim 3, wherein the server searches the pre-stored multimedia data bases according to the first output image for determining whether the pre-stored multimedia data bases comprise the multimedia data as the same as the video data displayed on the first electrical device by a facial recognition, a text recognition, or a voice recognition method.

6. The data transmission system of claim 4, wherein the server searches the pre-stored multimedia data bases according to the first output image for determining whether the pre-stored multimedia data bases comprise the multimedia data as the same as the video data displayed on the first electrical device by a facial recognition, a text recognition, or a voice recognition method.

7. The data transmission system of claim 1, wherein the electrical device data comprises a model number, location information, an image of the external appearance and a brand name.

8. The data transmission system of claim 1, wherein the pre-stored multimedia data bases comprise a plurality of files and information which are uploaded by the registered electrical device.

9. The data transmission system of claim 1, further comprising a third electrical device which is registered in the server, wherein when the second electrical device displays the video data, the second electrical device takes pictures for the third electrical device by the camera to generate a second output image and transmit the second output image to the server, the server transmits the video data displayed on the second electrical device to the third electrical device by recognizing the second output image.

10. An electrical device, comprising:
an image capture unit, taking pictures for other electrical device to generate a first output image and transmitting the first output image to a server, multimedia data bases, recognizes the other electrical device and a video data displayed on the other electrical device according to the first output image, and transmits the video data to the electrical device.

11. An electrical device, comprising a plurality of electrical device data and pre-stored multimedia data bases, wherein the electrical device receives an output image which is generated by a first electrical device taking pictures for a second electrical device, recognizes the second electrical device and a video data displayed on the second electrical device and transmits the video data to the first electrical device.
